(19) United States
(12) Patent Application Publication
(10) Pub. No.: US 2006/0055128 A1
(43) Pub. Date: Mar. 16, 2006

(54) Multi style golf cart towing device

(76) Inventors: Keith Howard Scott, Thousand Oaks, CA (US); Joel T. Chitiea, Thousand Oaks, CA (US)

Correspondence Address: PKK DEVELOPMENT LLC, 1442 OBERLIN AVENUE, THOUSAND OAKS, CA, 91360-2039, US

(21) Appl. No.: 10/944,360

(22) Filed: Sep. 16, 2004

(51) Int. Cl. B62D 51/04

(52) U.S. Cl. 280/1.5

(57) ABSTRACT

Multi-type pull style golf cart towing device. Composed of a high-density polyethylene material, a lightweight, non-metallic material, thus preventing the unnecessary scratching of existing models of pull carts. Integrated into said device are two (2) quick attach, release and adjustment segments. Set in two (2) key positions, thus allowing our apparatus to accommodate people measuring 4 ft. to over 6 ft 6″. Main Bar accommodates the integration of the scorecard holder, which is found on all common golfing pull carts. A golfer need only once set this apparatus to fit their physique before their 5 mile walk around the golf course. The novel construction includes a lightweight, extremely stable, non binding padded belt attachment that is adjustably attached to this device, keeping the mechanism flowing with the natural walking gait of the user. Allowing the user to perform all of the physical functions necessary for golf without restrictions

### BACKGROUND OF THE PATENT APPLICATION

Our invention is a hands free multi style golf cart carriage for the intended use of all golfing pull style carts. The creation of this high-density polyethylene, non-metallic device supersedes all other prior art for the hands free use of transporting all of today's styles of golfing pull carts over the entire length of an average (4-5 miles) golf course. Our invention, with it's novel high-density polyethylene main housing unit is compatible with all of the numerous types (main structural bars) of golfing pull carts in use today. Our apparatus uses two (2) adjustable pressure tension ratcheting clamps, allowing people from 4 ft to over 6′6″ ft. to use comfortably. The construction of prior art was severely deficient in several ways. Not only is the prior art mechanically inferior and over engineered any one familiar with the art would certainly have great difficulty constructing and applying said art. Metal against metal construction could never provide the necessary pressure to secure the device to the main structural bar of a normal pull cart without causing extensive damage to the main structural bar of said pull cart for even the very slightest amount of usage. Additionally, prior art would be even more destructive to composite materials used for the main structural bars of more recent models pull carts. A Golf course with diverse topography can range from 5000 yards to over 7000 yards 4-5 miles) plus the distance from putting surfaces to the next teeing area over varying terrain. The damage done to a golfers cart precludes the use of any previous devices. The main structural bar attaching clamp from previous art fails to withstand the enormous pressure applied during a normal round of golf thus prohibiting even the brief usage of the prior art. Prior art of this type of towing device did not factor in one of Earth's most prominent forces, Gravity. Pull carts loaded with a full set of golf clubs weighs between 30 to 40 pounds. Said pull cart, must be tipped to approximately 15° to 20° to balance on its two (2) wheels. Without this required angling of the loaded pull cart, the bottom of the bag/cart will drag on the ground, tipping the cart on its side upon taking one step. When applied for the purpose of towing a golf cart, prior art fails to maintain with stability the proper angle of the pull cart to navigate successfully the diverse terrain, which is a golf course. Furthermore, prior art provided virtually no stability in the second most critical area consisting of the waistband. Factoring in the normal up and down motion of a natural walking gait over varied terrain, previous devices would shake so violently thus precluding usage for the shortest of distances. In response to aforementioned devices, we have engineered a device that will fit on any available golfing pull cart. Our apparatus will accommodate the standard accessories that are attached to the main structural bar of the pull carts manufactured today i.e.: Golf Ball, Tee holders, and scorecard holder. Our device accommodates not only these attachments but a variety of others as well. Our invention is adjusted once to fit the wearer at the start of a round of Golf No adjustments are necessary for the entire 4-5 mile journey. The unique clamping system will not damage the golfers pull cart in any way. Our novel waistband will not bind or bother the wearer over the said length of the golfers round, We have engineered a stronger, age resistant and functionally superior apparatus using High-Density Polyethylene (HDPE) component construction. The main housing unit contains a vertical pressure bar, which is attached to the main housing unit by a novel male-female grooved sliding track. This bottom-sliding track is embedded with two (2) threaded nuts, permanently attaching the vertical pressure adjustment bar by shouldered threaded bolts. These bolts are then secured by a tightening ball on the bottom and a washer and threaded nut on the top shoulder. Uniquely using Magnetic technology, we have embedded in the high-density polyethylene four (4) magnets, one into each side of the male groove of the bottom sliding track, and one into each side of the female groove of the main housing unit.

Significant improvement does not come close to describe our apparatus versus the prior art. Our device performs without failure over five (5) miles of rugged topography with no adjustments needed or damage done to pull carts. Our main housing unit fits the structural main bar of all past and current pull carts presently available for use. The vertical pressure bar insures a non-slip connection by using magnetic technology, a novel bottom-sliding track, and knurled finish top insuring a non-slip seal. Unlike prior art, the two (2) threaded bolts attached to the vertical pressure bar are the only moving parts in the most critical main housing unit. As such, our unit greatly simplifies the function of attaching said main housing unit to the main structural bar of the pull cart. Novelly engineered into the main housing unit is the first of two (2) critical round pressure tension adjustable ratcheting clamps. Thirty (30) Pyramid cut grooves prevent slippage and movement and allow for unprecedented vertical (Height) adjustments. Lightweight construction materials provide unsurpassed strength and portability. Our device is the only device of its kind that completely offers the functionality not present in prior art.

### SUMMARY OF THE INVENTION

This present invention provides a golf cart towing apparatus that distinguishes itself over the prior art, as a device that works for the length of a full round of golf

An object of the present art is to craft a functionalble carriage device for golfing pull carts that can be applied to all currently available golfing pull cart devices.

Furthermore, another primary object of the apparatus is the direct integration to the main structural bar of the pull cart in the manufacturing process of said devices in production presently.

Yet another object of the present invention is to provide a useable device that has to date, not been made available for general use. The present art is simple to use and inexpensive to manufacture.

Still another, object is to use environmentally friendly material, which will not deteriorate, rust, dent or bend as does metal and or polyvinyl chloride when exposed to ultra violet sunlight, water or hard usage.

One more object of said device is to provide an area for the attachment of the scorecard & Golf ball & tee holders which come standard with today's versions of the golfing pull cart. Including but not limited to additional accessories.

Another object is to provide relief from hand, wrist, and arm and back fatigue associated with pulling a golf cart 4 to 5 miles over diverse terrain.

Accordingly, an object of the present invention is to afford the walking golfer a less strenuous round adding to the enjoyment of golfing.

Yet another object of this invention is to lower the score for the average golfer by reducing the amount of energy needed to traverse an average length golf course, thus affording more energy to actually playing the game.

Making a novel device of the following characteristics is detailed in the claims following. Construction and its preferred embodiment are best understood in conjunction with the following articles.

### BRIEF DESCRIPTION OF THE DRAWINGS

FIG. 1 Is a schematic view of the unique characteristics of the multi adaptable type golf pull cart apparatus. Shown with its two adjustable clamps attached to the pull cart and a golfer.

FIG. 2 Side view of high-density polyethylene Main Housing unit with the unique vertical pressure inner bar, height adjustment pressure tension ratcheting pyramid grooved clamp. Included is male-female bottom slotted sliding bar and tightening balls.

FIG. 3 Front view of high-density polyethylene clamp attachment with views of grooved circular hand tightening balls for the vertical tension bar. Emphasis on inner contour of main housing unit with its half-round molding, accommodating all styles of pull carts used currently.

FIG. 4 Shows an exploded view of the innovative Three-sided main housing unit with center vertical pressure pressure adjusting bar. Sliding male-female slotted bottom clamp with embedded threaded nuts, embedded magnetic strips, textured circular tightening balls attached to shouldered threaded bolts, washer and top threaded nut assembly.

FIG. 5 A cross sectional side view of the preferred embodiment.

FIG. 6 Overall Top view of the preferred embodiment.

FIG. 7 Three-dimensional view of main extension bar illustrating pyramid grooved end clamps for height adjustments of such varied heights. Accommodates all accessories as the standard score board illustrated.

FIG. 8 Top sectional view of padded main belt attachment. Adjustable heavy fabric straps anchored by the releasable male-female attaching clips to complete belt attachment to user waist.

FIG. 9 Top view of the second pressure tension height adjustment ratcheting clamp and the 180° swiveling shaft assembly.

FIG. 10 Three Dimensional View of the novel 180° swiveling waistband attachment.

FIG. 11 Top view of heavy fabric adjustable straps and the releasing male-female attaching clips. Glove holder and Cellular telephone attachments are mounted on said fabric.

### DESCRIPTION OF THE PREFFERED EMBODIDMENT

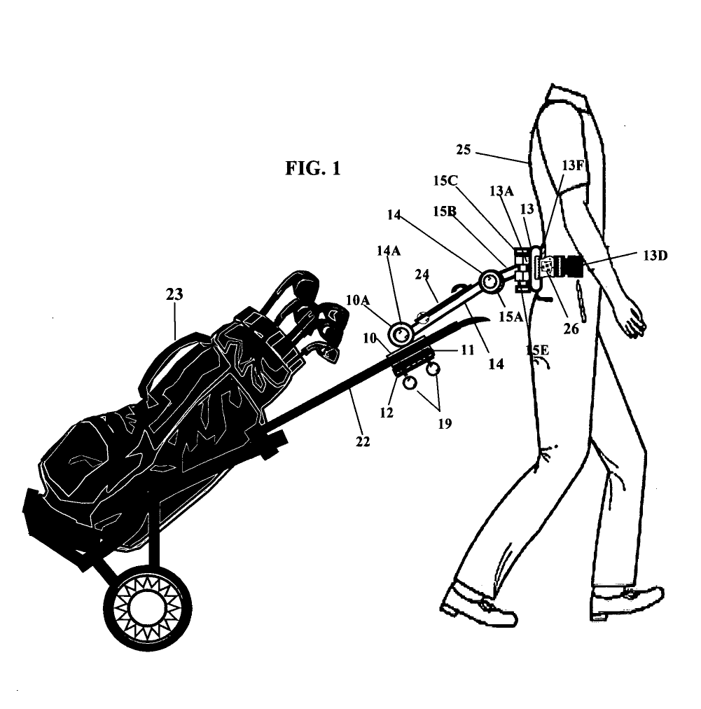

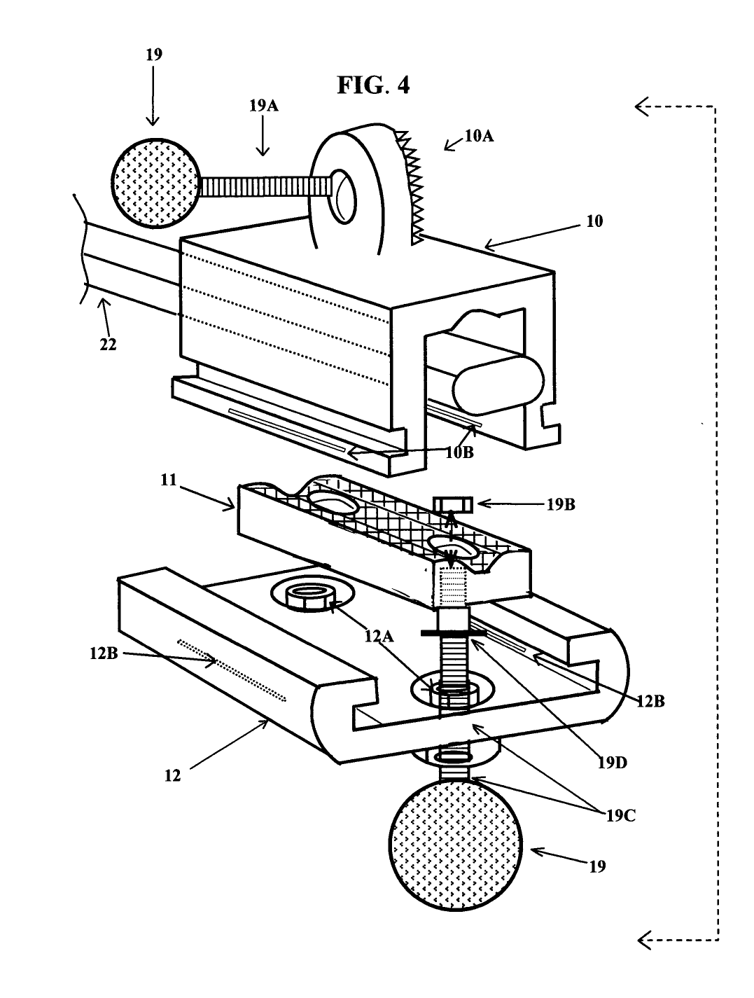

Referencing the provided drawings of the novelty and the preferred embodiment of the present art. Illustrating the preferred method of embodiment, FIGS. 1, 2 and 3 detail the importance of the main housing unit 10. The main housing unit 10 is attached to the main structural bar of a common golf pull cart 22 by placing said unit 10 on the top of aforementioned pull cart main structural bar 22. By sliding our novel male-female grooved sliding plate 12 underneath said pull carts main structural bar 22 into its complimenting grooves on said unit 10 completing the first of two (2) connection points of these critical joints for the successful embodiment of the present art. Applying a clockwise tightening motion to the high-density polyethylene tightening balls 19 securely fastens the main housing unit 10 to aforementioned main structural bar 22 of said pull cart by the use of our novel vertical pressure bar 11 shown in greater detail in FIG. 4. Furthermore, said main housing unit 10 is attached by our novel adjustable pressure tension ratcheting clamp connector 10A to the main structural center bar 14 which provides capacity for attachments including, but not limited to, the standard features for the average golf pull cart 24. Using the unique adjustable pressure tension-ratcheting clamp 14B in its second critical and novel placement said clamp connects with its mirrored adjustable pressure tension-ratcheting clamp 15A. The angled stability shaft 15B is permanently affixed to the mobile vertical shaft 15C which provides 180° mobility for the user by rotating securely within the circular seat provided by its attaching assembly 15D/13A and 15E/13B. The vertical shaft 15C attaches to a sturdy, high-density polyethylene padded waistband 13 and accordingly the girth adjustable nylon corded straps 13C. Completing this belt are quick attach and release male-female connector clips 13D/13E for attachment to the waist of the golfer 25. The use of said nylon strap as shown is illustrated with a novel Golf glove holder or cellular telephone clip but is not limited to this or other attachments 26.

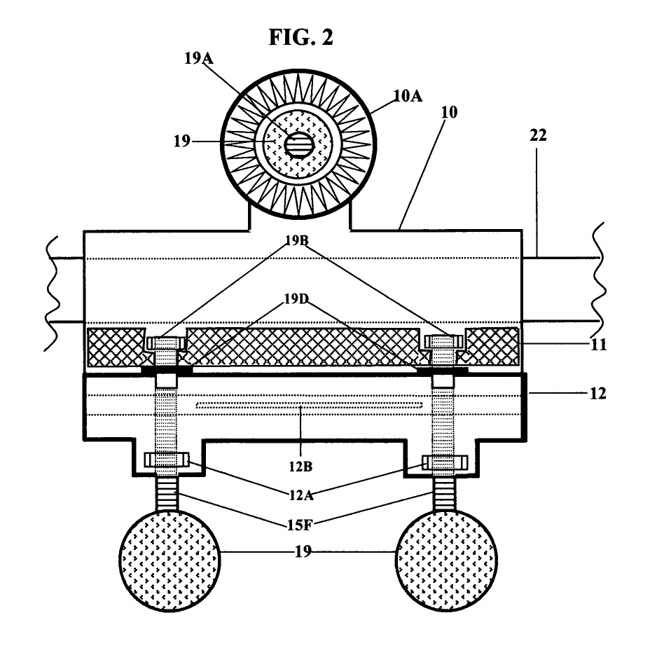

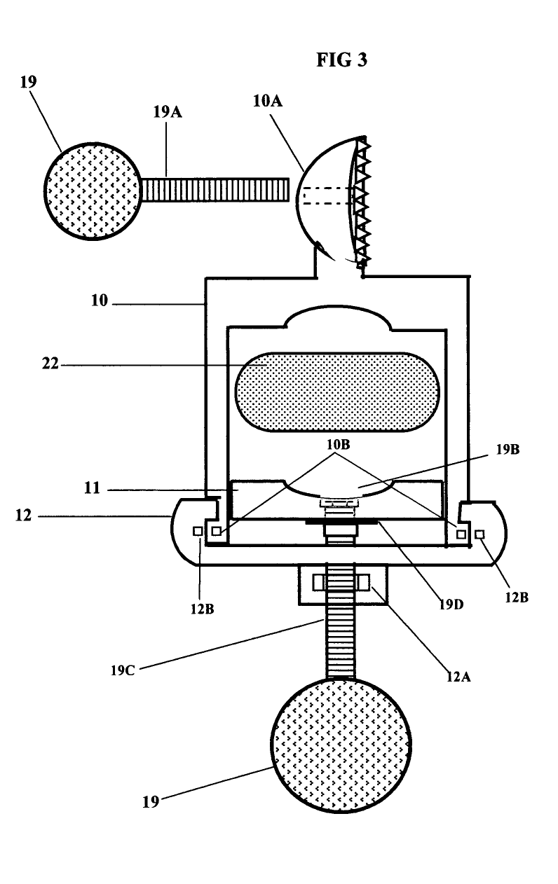

Examining the invention in detail, we find the originality of the present art in FIGS. 2, 3, and 4. The side views in FIGS. 2 and 3 illustrate the simplicity of the main housing unit 10. Placing aforementioned main housing unit 10 on top of the pull carts main structural bar 22 and sliding our novel male-female grooved sliding plate 12 underneath said structural bar 22 into complimenting grooves on said main housing unit 10 completes the primary attachment of the two (2) critical junctions. In addition, uniquely using magnetic inserts 10B/12B embedded within both sides of the male section of the main housing unit 10 and both sides of the grooved sliding female bottom unit 12 provides the primary connection between those two units in the successful embodiment of the current art. An exploded view FIG. 4 exhibits the knurled finish vertical pressure bar 11 which is attached by the use of two (2) threaded shoulder bolts 19C, two (2) washers 19D, and two (2) locking threaded nuts 19B. Embedded into the unique male-female grooved bottom locking plate 12 are two (2) threaded nuts 12A for each high density polyethylene tightening ball and its embedded threaded bolt 19/19C. Thus providing the adjustable pressure needed for a secure grip on the main housing unit 10 to various main structural bars 22 of golfing pull carts. The final non-slip connection is made by hand tightening in a clockwise fashion the high-density polyethylene tightening balls 19 forcing the vertical pressure bar 11 against the main structural bar of the golf pull cart 22. This non-slip connection is critical to the novelty of the invention, as no damage will occur to the main structural bar of the golf pull cart 22. Continuing in FIG. 4 an integral part of the main housing unit 10 is a novel pressure tension ratcheting grooved clamp 10A which doubles as the connector to the main bar 14 of our creation and provides the first of two novel pressure tension ratcheting clamps 14A and 14B for adjusting the device to heights varying from 4 ft to 6′6″ ft. As with the locking grooved female bottom plate 12 of the main housing unit 10, hand tightening in a clockwise fashion to a personal preference is used to secure said clamp 14A and 14B to the main housing unit 10A and the stability bar assembly at the waistband junction 15A.

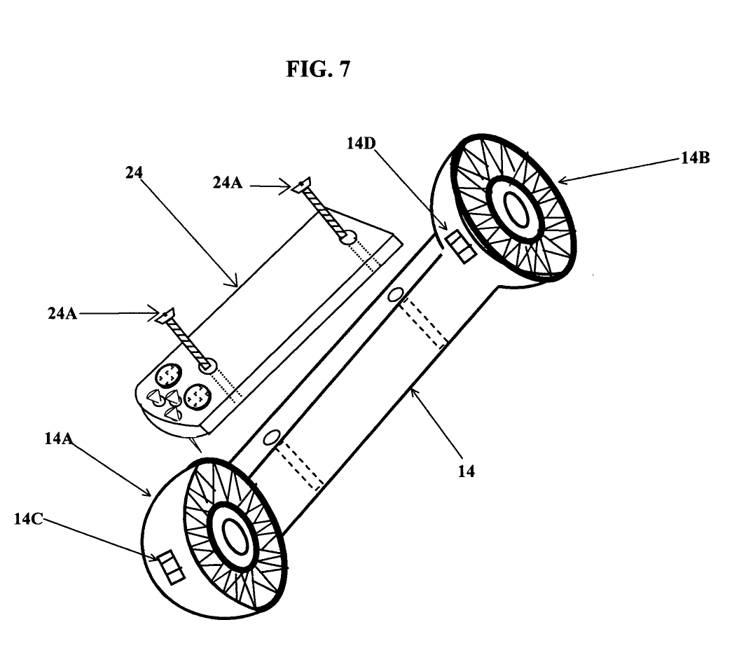

The preferred embodiment now proceeds to FIG. 7. The main bar 14 of the device novelly provides for accessories which include but are not limited to a Golf ball and Tee holder and the Scorecard holding plate 24 which come standard with most pull carts today. Included in this illustration are the embedded threaded nuts 14C and 14D, which are used for the height adjusting pressure tension ratcheting clamps 14A and 14B. High-density polyethylene is used for the construction of the main bar 14 and the aforementioned clamps 14A and 14B. Our novel second connection point 14B is absolutely necessary for the correct embodiment of a device for the towing of a golf pull cart. Any art must have this critical second pressure tension ratcheting clamp. It allows for a height adjustment point, which is critical for apparatus stability, user comfort and most importantly, the proper angling of the pull cart. This critical stability point is secured by the use of high-density polyethylene ball and embedded bolt 19/19A. Significantly and uniquely on this device, the second high-density polyethylene adjustable pressure tension ratcheting clamp 14B provides this additional height adjustment point. It also provides additional strength at the connection between the golfer 25, the belt 13, and the main bar 14 of the device.

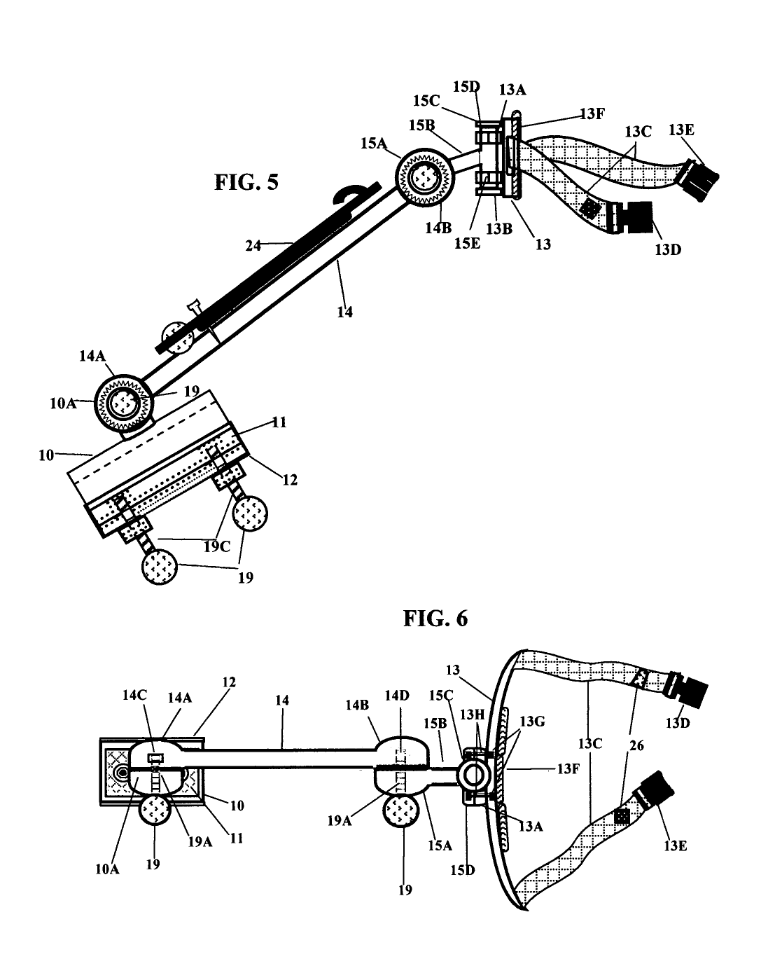

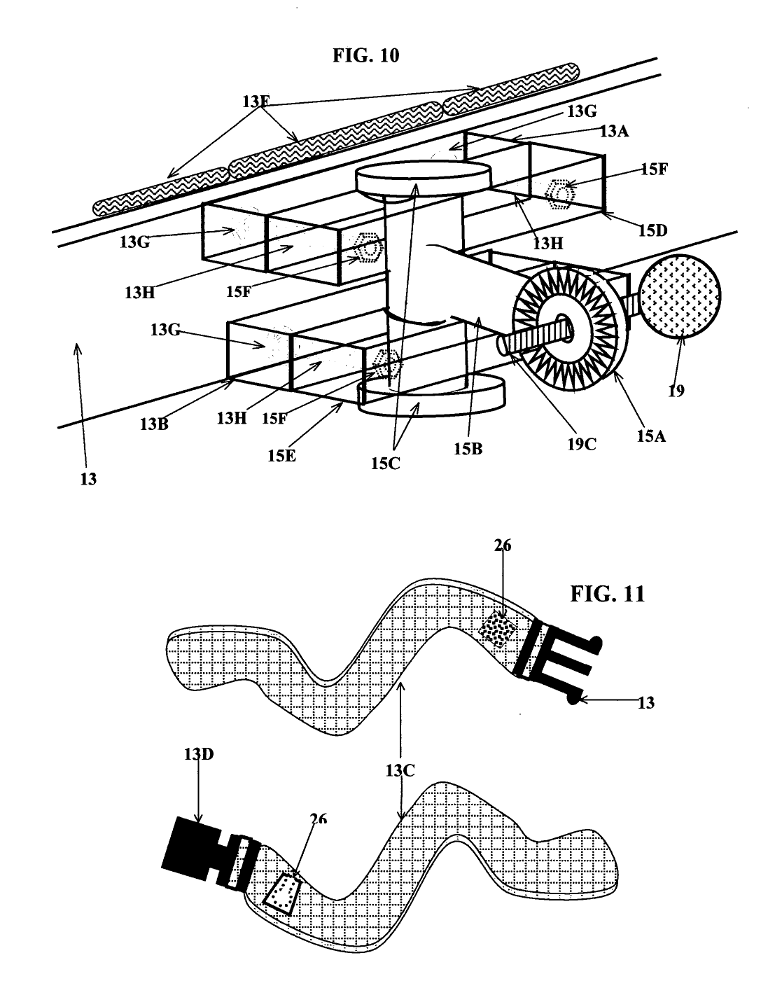

FIG. 10, Illustrates in detail the waistband and its critical connection, mobility, stability features. Starting at the second height and stability point 15A which connects to short stability shaft 15B which is integrally affixed to a vertical round 180° rotating shaft 15C. The attached embodiment to the high-density polyethylene waistband 13 is in two places. Two (2) rounded attaching bars 15D/13A and 15E/13B allow the vertical round shaft assembly 15C to swivel 180° while offering unprecedented stability and uniformity according to each individual physique and walking gait. FIGS. 5 and 6 offer both the side and top view of the preferred embodiment of the present invention.

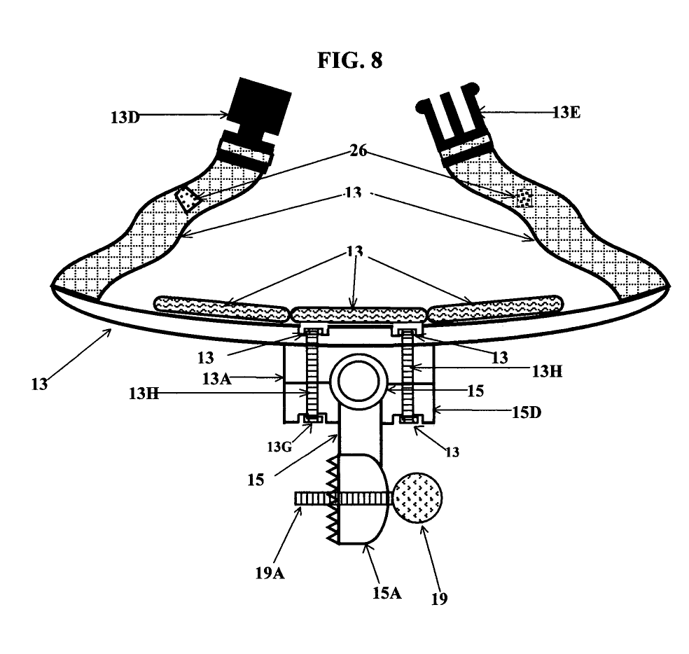

FIG. 8 illustrates the top view of the preferred embodiment's novel attachment of the critical main bar 14A to waistband junction 15A beginning at the adjustable pressure tension ratcheting clamp 14B. The high-density polyethylene waistband is attached to this critical clamp, stability and swivel assembly 15A, 15B, and 15C by two (2) rounded attaching bars 15D and 15E. These are secured by two (2) threaded connecting bolts 13H to two (2) threaded nuts 13G per each assembly bracket. Said attachment components 15D and 15E are set into each side of the upper and lower corresponding brackets 13A and 13B, which are integral parts of the molded waist band 13 thus providing our novel circular seat.

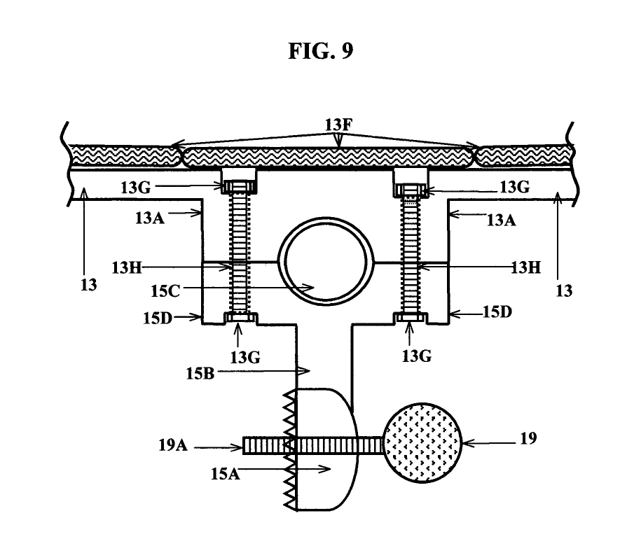

Particular emphasis now being placed on FIGS. 8, 9 and 10. Illustrating the waist band 13 made of high density polyethylene construction with a water resistant covered fabric foam padded back rest 13F attached to the waist band 13 by the use of rivets or the like but not limited to. The FIGS. 6, 8 and 11 also illustrate the attachment of heavy-duty nylon or cloth girth adjusting belts 13C and their individual adjustable large plastic male-female quick attach/quick release clips 13D/13E. The heavy-duty belts 13C are attached to the waistband 13 through slots in the side of the waistband and are sewn, riveted or attached securely but not limited to these methods. The user, when pulling down either end of the girth adjustment belts 13C to attach the device to their waist, automatically tilts the golf pull cart to the correct angle 15° to 20° for proper embodiment and uninhibited ambulation of their 4 to 5 mile golf round. The golf pull cart can be attached when the user is already walking thus freeing the user to enjoy a soft drink, indulge a cigar, or use various other optional attachments which are not limited to the aforementioned articles.

The preferred embodiment of our novel and distinctive harness is not limited to the embodiment described above. The embodiment described in the above description can be fully integrated into all current golfing pull carts in use presently as fully integrated blended harness applied directly into said pull carts main structural bar 22. The requested letter of patent is intended to be applied to all golfing pull carts. Our art currently can be applied integrally to all pull carts and the like but not limited to said usage. Various changes may be made to the invention without departing from the spirit thereof or the scope of the following claims which is new and desires to be secured by a Patent.

Our Apparatus has been tested extensively, over various terrain and in multiple conditions from ideal to severe with out failure. Therefore we claim the following and desire our invention to be secured by a Patent for application to all two wheeled golfing pull carts.

1. An apparatus for transporting the entire weight of a fully loaded (30 to 40 lbs.) two wheeled golfing pull cart by the torso of a human being without the use of hands the entire length of a normal golf course (4 to 5 miles).

2. The critical component of the present art is the main housing unit and its novel internal pressure adjusting clamp. It will not slip, causing the immediate failure and damage to a freely rolling pull cart.

3. The device further claims to have one (1) moving part in its main housing unit, which is adjusted by two (2) threaded hand tightening balls.

4. Wherein the enhancement comprising from claim Two (2), it will not damage the users pull carts main structural bar.

5. Concomitantly as stated in claim Two (2), that its'main housing unit, is compatible to all two wheeled golfing pull carts currently in use.

6. The device further claims a novel use of magnetic technology embedded in the clamping structure.

7. The device also claims to be constructed of environmentally friendly high-density polyethylene.

8. As stated in claim Seven (7), our device whereupon it's betterment, comprises to be of such a lightweight, as the user is not burdened by substantial extra weight.

9. Our device employs two (2) novel attaching pressure tension pyramid grooved ratcheting clamps made of high-density polyethylene or the like materials allowing for correct height adjustments.

10. As defined in claim Nine (9), our device is adjustable for height in two (2) separate areas.

11. Wherein the improvement comprises our device as defined in claim Nine (9) fits people of height from 4 ft to 6 ft 6 inches.

12. The device claims a waist belt of high density polyethylene, or the like, providing sufficient strength to support a person's torso over varying terrain and distances.

13. In conjunction with claim Twelve (12), the high-density polyethylene waistband is constructed with a water-resistant covered fabric padding.

14. The device also claims to have a superior releasing mechanism affording the normal user easy on & off capabilities.

15. Referencing claim Fourteen (14), wherein an improvement comprises that our device is readily convertible for a left-handed golfer.

16. The device claims to be removable from a pull cart and be collapsible as to fit in a normal golf bag.

17. The device claims, wherein the improvement comprises from claim Sixteen (16), it does not require removal from the pull cart for normal storage of said cart.

18. The device further claims to offer installation capabilities, which include but are not limited to attachments, which come standard on current, pull carts.

19. The device claims to be inexpensive to manufacture and simple to use. Thus affording golfers of all economic backgrounds to use.

20. The device is intended and can be completely and wholly integrated into the manufacturing process for all current two wheeled pull carts.
